(19) United States
(12) Patent Application Publication
(10) Pub. No.: US 2004/0254064 A1
(43) Pub. Date: Dec. 16, 2004

(54) Method for electrolytic heterocoupling between an aryl(pseudo) halide and an ester containing an ethylenic unsaturation, use of cobalt in order to carry out said coupling and composition therefor

(76) Inventors: Jacques Perichon, Savigny-sur-Orge (FR); Corinne Gosmini, Savigny-sur-Orge (FR); Paulo Gomes, Le Perreux (FR)

Correspondence Address: BURNS DOANE SWECKER & MATHIS L L P, POST OFFICE BOX 1404, ALEXANDRIA, VA, 22313-1404, US

(21) Appl. No.: 10/482,292

(22) PCT Filed: Jul. 3, 2002
(86) PCT No.: PCT/FR02/02322

(30) Foreign Application Priority Data
Jul. 3, 2001 (FR) 01/08807
Jul. 3, 2001 (FR) 01/08808

(51) Int. Cl. B01J 31/00

(52) U.S. Cl. 502/150; 502/155; 502/167

(57) ABSTRACT

This invention has as its object a process for preparation of vinyl aryl derivatives by an electrochemical method.

This process is defined in that it consists in subjecting a composition that comprises a cobalt salt, an aromatic halide and a vinyl ester to electrolysis on an inert cathode.

This invention has as its object a process of synthesis of a vinyl aryl or allyl aryl compound starting from a reaction of heterogeneous coupling by an electrolytic method between aryl compounds and vinyl compounds or allyl compounds.

It aims more specifically at the use of cobalt salts, in particular cobalt(II) salts, as electrochemical coupling catalysts between an aryl derivative and a vinyl derivative.

As for the coupling between vinyl derivatives and aryl derivatives to yield vinyl aryl derivatives, there is almost no description of it. The only document relating to it is the report published in Tetrahedron, Volume 48, No. 4, pages 719 to 726, where a reaction of this type is described in the presence of palladium(II) salts that are supported on silylated montmorillonite. No mechanism is proposed, and the absence of elements described above does not make it possible to propose even one balanced reaction equation because as soon as they are solved, all of the proposed reaction equations lead to apories.

These reactions would, however, allow easy and particularly advantageous access to useful, complex derivatives, in particular in the fields of pharmacy and agrochemistry.

This is why one of the objects of this invention is to provide a coupling process between vinyl derivatives and aryl derivatives that does not require the use of expensive catalysts. Another object of this invention is to provide a process of the preceding type that furnishes good yields.

Another object of this invention is to provide a process of the preceding type that is doubly ipso, the bond between the vinyl molecule and the aryl molecule being accomplished at the site where the two leaving groups were found.

Another object of this invention is to provide a process that yields few parasitic reactions, in particular a reaction that yields little symmetrical coupling and that yields few reductions to lead to hydrogenated compounds in place of the leaving groups.

As for the coupling between allyl derivatives and aryl derivatives to yield allyl aryl derivatives, there is almost no description of it.

These reactions would allow, however, easy and especially advantageous access to useful, complex derivatives, in particular in the fields of pharmacy and agrochemistry.

This is why another object of this invention is to provide a process of coupling between allyl derivatives and aryl derivatives that does not require the use of expensive catalysts. Another object of this invention is to provide a process of the preceding type that furnishes good yields.

Another object of this invention is to provide a process of the preceding type that is doubly ipso (here, the ablative of the Latin “ipse” is used to indicate that functionalization is done on the same carbon as the one that the leaving group was carrying), the bond between the molecule that carries the unsaturation, in particular allyl, and even homoallyl, and the aryl molecule being accomplished at the site where the two leaving groups were found.

Another object of this invention is to provide a process that yields few parasitic reactions, in particular a reaction that yields little symmetrical coupling and that yields few reductions to lead to hydrogenated compounds in place of the leaving groups.

These objects and others that will appear below are achieved by means of a process of electrolytic heterocoupling between an aryl (pseudo)halide and an ethylenic unsaturation carrier and a leaving group, advantageously an ester, and even an ether, in particular of allyl and vinyl, which consists in subjecting the two substrates to a cathodic reduction in the presence of cobalt

Although the form of the cobalt in the vicinity of the cathode had not been completely explained, it was possible to show that the presence of cobalt coordinating agents proved important and made it possible to modify the yields very significantly. It could be that this presence may have a role in the optional coordination between the ethylene unsaturation and the cobalt.

Remembering that an ester is defined as the product of condensation between a carrier of a hydroxyl function and a Bronstedt acid, i.e., a carrier of an acidic hydrogen, unsaturation is advantageously near the atom that was the carrier of the acidic hydrogen, i.e., said carrier atom is advantageously in vinyl-position, allyl- position, or even homoallyl-position, preferably in vinyl-or allyl-position.

The reaction can be written roughly as follows:

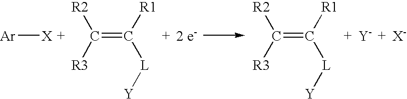

Formulas in which L represents a divalent arm ensuring the link between the vinylic unsaturation and the remainder of the acid (Y is noted here) after having ignored-hydrogen. Thus, when the ester is vinylic, L is absent, —L— symbolizing then the single bond linking Y and the vinylic unsaturation. When —L— represents something other than a single bond, L is advantageously an alkylene group; preferably ethylene or methylene, more preferably methylene. In the latter case, the ester is allylic.

Formulas in which Y corresponds to a leaving group that can exist in Y⁻ form, such as phenate, and even alcoholate, but advantageously selected from among the halogens and the carboxylates lato sensu and the pseudohalogens. It is desirable that it be such that the YH acid has a pKa (measured in water) that is at most equal to 9, advantageously 7, and preferably 5. It is advantageously selected from among the halogens and carboxylates lato sensu and the (pseudo)halogens.

The case where Y is such that it forms an ether with the compounds that carry an ethylene double bond is hardly to be considered except when aryl-allyl coupling is intended.

A pseudohalogen is defined as a group whose removal leads to an oxidized anion, the anionic charge being carried by the chalcogen atom and whose acidity is at least equal to that of acetic acid, advantageously to the second acidity of sulfuric acid and preferably to that of the trifluoroacetic acid. To be located on the scale of acidities, it is a good idea to refer to the pKa for medium to strong acidities starting with carboxylic acids to acetic acid and to be located on the scale of Hammett constants starting from trifluoroacetic acid.

Carboxylate lato sensu is defined as any radical such that its anionic form comprises the atomic sequence —CO—O⁻; thus not only are the carboxylate functions being linked to one carbon atom intended, but also carbamic acids and alkyl carbonates.

If it is desired to avoid all parasitic reactions, it is preferable to avoid the substituents comprising reactive hydrogens such as hydrogens on the amides (that are therefore advantageously protected or peralkylated) or on an oxygen.

Formulas in which R₁, R₂ and R₃, which may or may not be different, are selected from among hydrogen, the functions that are more difficult to reduce than the function Y, and among the hydrocarbon radicals in particular alkyls and aryls.

Thus, among the functions that are more difficult to reduce than Y, it is possible to cite, when Y forms an ester, the ether functions, the carboxylic functions (linked or not to the remainder of the molecule by the carbon), the functions among which Y is selected provided that these functions are less reducible than Y. The order of reducibility can be easily determined under operating conditions by routine experiments. Purely by way of indication, it can be noted that regarding the halides, the higher the atomic number, the more the halide is reducible and more generally (and more roughly) the stronger the acid is which corresponds to the leaving group, the more the ester of the corresponding vinyl is reducible (but it should be noted that the anions can themselves be reduced and cause parasitic reactions).

Among the groups that are relatively reducible and that should be emphasized, it is possible to cite the perfluorinated groups: one of the solutions is to influence the current density.

The hydrocarbon radicals are preferably either of an aromatic nature or an aliphatic nature, i.e., the carbon that ensures the link to the remainder of the molecule is hybridization carbon sp³; these aliphatic radicals are in general alkyls (alkyl is used in the etymological meaning of an alcohol from which the OH function is removed), including aralkyls. It should be pointed out that the hydrocarbon radicals that have a double bond. conjugated with the double bond yield only very mediocre results.

To be effective, it is desirable that the cobalt be present at a minimum concentration of at least 10⁻³ M.

To be economical, it is preferable that the cobalt not be overly concentrated, rather it is preferred that the cobalt content be at most equal to 0.2 M.

The reaction medium advantageously comprises a solvent, and this solvent should be polar enough to dissolve metals or more exactly the salts of the metals used, and it should be lipophilic enough to dissolve, at least partially, the substrates from which it is desired to form the vinyl aryl.

It is preferable to use solvents with such low acidity that the reactions with hydrogen are as little pronounced as possible. Thus, the primary alcohols are too acidic.

More specifically, said polar aprotic solvents such as the following, for example alone or in a mixture, wilt be preferred:

Purely oxidized solvents, in particular ethers, preferably polyethers such as dimethoxy-1,2-ethane or cyclic ethers such as THF or dioxane;

amides or ureas (DMF, N-methylpyrrolidone-2, imidazolidone, tetramethyl urea, dimethoxypropylene-urea, etc.);

sulfones (for example sulfolane) or sulfoxides (such as DMSO);

and, to the extent that they are liquid under operating conditions, nitrogen-containing derivatives, nitrogen-containing heterocyclic compounds, in particular pyridine, and compounds with a nitrile function (for those that are preferred, see below);

and, to the extent that they are liquid under operating conditions, complexing agents (crown ether, HMPT, tris-(dioxa-3.6-heptyl)amine (TDA-1) that improve the smooth running of the reaction by increasing conductivity, increasing the reactivity of the anion, and preventing metal deposits on the cathode.

Without this explanation being limiting, it would seem that these advantageous phenomena are correlated with the capacity to complex the metallic cations or in a mixture.

As indicated above, the solvents that are used can themselves play the part of complexing agents or coordinating agents. They can in particular, and this is advantageous, have one or more of the functions of coordination mentioned above.

The solvent can be a mixture of an apolar solvent and a polar solvent as defined above by the donor index.

To facilitate the separation of the products from the reaction media, it is preferable that said solvent has a boiling point that is significantly different from that of the compound to be synthesized and the starting compound.

To facilitate the reaction and improve the conductivity of the medium, in general saline electrolytes are used, sometimes called bottom salts, optionally modified by the presence of complexing agents. These electrolytes are selected such that they do not disturb the reactions on the anode and cathode. The latter is advantageously inert.

According to one of the most economical implementations of this invention, a salt whose cations correspond to metals of the anode can be used as a bottom salt if a soluble anode is used. Among the soluble anodes, it is possible to cite the anodes that contain iron and/or cobalt, and in particular the anodes that are made of cobalt alloy, of cobalt itself, or of ferro-cobalt.

The electrolyte can be selected so as to have as cations metals with a high transporting power such as the divalent metals, advantageously trivalent metals, or aluminum-type metals, provided that this does not disturb the basic reaction.

Among the metals that are used in the bottom salts, it is desirable to use those that exhibit, besides the degree 0, only a single degree of stable oxidation.

The electrolyte can be selected such that these cations are directly soluble in the reaction medium. Thus, in particular when the medium is not very polar, rather than to make the metallic cations soluble by means of adjuvants, it may be advantageous to use stable “oniums” in the domain of electric inactivity. “Onium” is defined as the positively charged organic compounds of which the name that attributes the nomenclature to them comprises an affix, in general a suffix, “onium” (such as sulfonium [trisubstituted sulfur], phosphonium [tetrasubstituted phosphorus], ammonium [tetrasubstituted nitrogen]). Most used are the tetraalkylammoniums, the alkyl groups that are taken in their etymological meaning in general have 1 to 12 carbon atoms, preferably 1 to 4 carbon atoms. It is also possible to use phase transfer agents.

The anions can be anions that are usual for indifferent electrolytes, but it is preferable that they be selected from among those that are released by the reaction, essentially halides, or, for example, by complex anions of type BF₄⁻, PF₆₋, or ClO₄⁻. Among the preferred anions, it is possible to cite those that are obtained from fluorinated acids or their imides (TFSI, triflates, etc.). By way of indication, it should be pointed out that DMF, used with tetrabutylammonium tetrafluoroborate as a bottom salt at the concentration of 0.01 M, yielded good results.

Said electrolysis can be conducted at many temperatures, but it is preferable to conduct this electrolysis at a temperature that is at most equal to 100° C. and at most equal to the boiling point of the solvent.

An interval yielding good results is the interval between 0 and 50° C.; it is a closed interval, i.e., including the limits.

Pressure is of little importance to the electrolysis, except if one of the reagents or the solvent has a particularly low boiling point.

For practical reasons, however, the pressure is preferably the atmospheric pressure of the location in question.

In the above-mentioned case where one of the components of the reaction medium is particularly volatile and where it is desired to keep this component in the reaction medium, it is then possible to increase the pressure; this pressure is generally then an autogenous pressure resulting from the reaction in a closed chamber.

The aryl substrates (Ar—X) that can be coupled to the compounds that carry an ethylenic unsaturation according to this invention represent a wide range of compounds. The halides are generally halides corresponding to relatively heavy halogens, i.e., halogens that are heavier than fluorine.

It can also be indicated that when the halogen is linked to an aromatic core that is low in electrons, it is preferable to use bromines or chlorines as halogen, the chlorines being reserved for cores that are particularly low in electrons. The condition is almost always met by heterocyclic compounds with six chain links, but in the case of homocyclic aryl hexacyclic substrates, to use a chloride, it is preferable that the sum of the Hammett constants σₚ of the substituents (not taking into account the starting halide) is at least equal to 0.40, preferably 0.50. By contrast, the cores that are particularly high in electrons can use iodine as a halide.

For more details on Hammett constants, it is possible, for example, to refer to the third edition of the manual written by Professor Jerry March “Advanced Organic Chemistry” (pages 242 to 250) and edited by John Wiley and Sons.

The heterocyclic compounds, with five chain links and that comprise as heteroatom a chalcogen (such as furan and thiophene), also yield acceptable results.

As was mentioned above, the reduction in electrons from the core can be caused either by the presence of electroattractor groups as substituents, or, in the case of cores with six chain links, by the replacement of a carbon by a heteroatom. In other words, the core that is reduced in electrons can be a heterocyclic core with six chain links, in particular the heterocyclic cores that have an atom from the column of nitrogen and more particularly the nitrogen.

Among the electroattractor groups leading to good results, it is suitable to cite acyl groups, nitrile groups, sulfone groups, carboxylate groups, trifluoromethyl groups or more generally perfluoroalkyl groups and halogens of a lower order than halide, which will be replaced by the allyl radical.

Among the donor groups, i.e., yielding mediocre results with chlorine, but good results with bromine, it is possible to cite alkyloxyl groups, alkyl groups, amine groups and dialkylamine groups.

The aromatic derivative substrate of this process corresponds advantageously to the following formula:

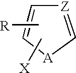

where:

Z represents a trivalent chain link —C(R₁)═, and an atom of column V, advantageously a nitrogen;

X represents the starting halogen;

A represents either a link that is selected from among the ZH groups or from among the chalcogens that are advantageously of an order that is at least equal to that of sulfur, or from among the unsaturated divalent groups with two chain links C R₂═CR₃—, N═CR₂ CR₂═N—.

To the extent that they are carried by the contiguous atoms, two of radicals R, R₁, R₂, and R₃ can be linked to form rings.

Thus, the aryls can have in particular the formula:

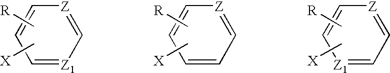

where:

Z₁ is selected from among the same meanings as those provided for Z;

radicals R₁, R₂, and R₃ are selected from among the substituents that are mentioned above and in particular:

electroattractor groups, in particular acyl groups, nitrile groups, sulfone groups, carboxylate groups, trifluoromethyl groups, or more generally perfluoroalkyl groups and halogens of a lower order than halide that will be transformed into a coupling product;

donor groups, in particular the aryloxyl groups, alkyloxyl groups, hydrocarbyl groups such as aryl and alkyl (the latter word being used in its etymological meaning), or amine groups, including groups that are mono- and disubstituted by alkylarnine hydrocarbon groups.

It is desirable that the substrates have at most 50 carbon atoms, advantageously at most 30 carbon atoms, and preferably at most 20 carbon atoms.

The particularly advantageous substrates include the halides, preferably aryl chlorides, that carry in particular in meta-position an aliphatic carbon (i.e., sp³) that carries at least two fluorines, for example halides, preferably trifluoromethylaryl chlorides.

It is preferable that the cobalt be coordinated, however, the optimum coordination conditions are a little different for the vinyl esters, on one hand, and for the other esters, especially allyl, on the other hand.

This description now pertains more specifically to the implementation in which the ester is vinylic; in this case, L is absent and therefore —L— is a single bond: the equation above then becomes:

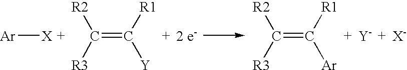

The vinyl, site of the reaction, provides only very mediocre results when it is conjugated with an ethylene double bond to provide a butadiene skeleton.

In general, the number of carbons of the vinyl derivative is less than 50, advantageously 30.

Actually, during studies that led to this invention, it was shown that in the presence of cobalt, the coupling above took place with good yields.

Although the form of the cobalt in the vicinity of the cathode had not been completely clarified, it was possible to show that the presence of cobalt coordinating agents proved important and made it possible to increase the yields very significantly. It could be that this presence may have a role in the optional coordination between ethylenic unsaturation and cobalt.

Although an effect can be demonstrated when solvents that have the property of coordinating the cobalt are used, it is preferable to use specific coordinating agents.

If a return is made to the agents or solvation agents that make it possible to improve the yield significantly, it is possible to indicate that it is possible to use compounds that have a high donor index. More specifically, it is possible to indicate that it is preferable that donor index D of these solvents, or of these solvation agents, be greater than or equal to 10, preferably less than or equal to 30, advantageously between 20 and 30, including the limits. Said donor index corresponds to ΔH (enthalpy variation) that is expressed in kilocalories of the combination of said polar aprotic solvent or said coordinating agent with antimony pentachloride.

This is described more specifically in the work of Christian Reichardt: “Solvents and Solvent Effects in Organic Chemistry” —VCH, page 19, 1988. On this page is found the definition of the donor index that is expressed in English terms by “donor number.”

The results are better if the atom that coordinates the cobalt in said solvent or solvation agent is an atom from the column of nitrogen, and advantageously the nitrogen itself.

When a specific coordinating agent that does not play the role of solvent is used, it is possible to cite the functions or group of pyridine, nitrile, phosphine, stibine and imine.

To be effective, it is desirable that the cobalt be present at a minimum concentration of at least 10⁻³ M.

To be economical, it is preferable that the cobalt not be too concentrated; it is also preferred that the cobalt content be at most equal to 0.2 M.

The reaction medium advantageously comprises a solvent, and this solvent should be polar enough to dissolve the metals or more exactly the salts of the metals that are used, and it should be lipophilic enough to dissolve, at least partially, the substrates from which it is desired to form the vinyl aryl.

It is preferable to use solvents that are low enough in acid so that the reactions with hydrogen are as little pronounced as possible. Thus, the primary alcohols are too acidic.

More specifically, the so-called polar aprotic solvents, such as the following, for example, alone or in a mixture, will be preferred:

Purely oxidized solvents, in particular ethers, preferably polyethers such as dimethoxy-1,2-ethane or cyclic ethers such as THF or dioxane;

amides or ureas (DMF, N-methylpyrrplidone-2, imidazolidone, tetramethyl urea, dimethoxypropylene-urea, etc.);

sulfones (for example sulfolane) or sulfoxides (such as DMSO);

and, to the extent that they are liquid under the operating conditions, nitrogen-containing derivatives, nitrogen-containing heterocyclic compounds, in particular pyridine and compounds with a nitrile function (for those that are preferred, see below);

and, to the extent that they are liquid under the operating conditions, complexing agents (crown ether, HMPT, tris-(dioxa-3.6-heptyl)amine (TDA-1)) that improve the smooth running of the reaction by increasing conductivity, increasing the reactivity of the anion, and preventing metal deposits on the cathode.

Without this explanation being limiting, it would seem that these advantageous phenomena are correlated with the capacity to complex the metallic cations or in a mixture.

As indicated above, the solvents that are used can themselves play the part of complexing agents or coordinating agents. They can especially, and this is advantageous, have one or more of the functions of coordination mentioned above.

The solvent can be a mixture of an apolar solvent and a polar solvent as defined above by the donor index.

When the solvent is not in itself a complexing agent of the cobalt that is strong enough to obtain optimum results, it is then desirable to use one of the complexing agents that is specific for cobalt, advantageously polydentate, most often bidentate. As functions that play the role of teeth, it is suitable to cite the nitrites (preferably aromatic and/or bidentate nitrites), or else the pyridines and the derivatives of the pyridine core, such as quinoline.

The bipyridyls, being bidentate, thus also yield very good results as separate coordinating. agents of the solvent. The preferred complexing agents are those that do not carry a charge, primarily negative, on the atom, or the atoms that carry the bond, coordinating the cobalt; it is also preferable that when said complexing agent carries a charge, the latter is located by the shortest path to at least 4 and even advantageously to at least 5 atoms, preferably 6, primarily when said charge is negative. The cyanides thus are not desirable as a complexing agent of the cobalt.

To obtain improved results and yields, it is preferable that the ratio (coordinating agent(s)/cobalt) between coordinating agent(s), expressed in mol for the monodentates and in equivalent terms for the polydentates and the cobalt ions (expressed in mol), be at least equal to 0.5; advantageously 1, preferably 2, and more preferably 4.

To facilitate the separation of the products with the reaction media, it is preferable that said solvent has a boiling point that is essentially different from the compound that is to be synthesized and the starting compound.

To facilitate the reaction and to improve the conductivity of the medium, in general saline electrolytes are used, sometimes called bottom salts, optionally modified by the presence of complexing agents. These electrolytes are selected such that they do not disturb the reactions on the anode and cathode. The latter is advantageously inert.

According to one of the most economical implementations of this invention, a salt whose cations correspond to metals of the anode can be used as a bottom salt if a soluble anode is used. Among the soluble anodes, it is possible to cite the anodes that contain iron and/or cobalt, and in particular the anodes that are made of cobalt alloy, of cobalt itself, or of ferro-cobalt.

The electrolyte can be selected so as to have as cations metals with a high transporting power such as the divalent metals, advantageously trivalent metals, or aluminum-type metals, provided that this does not disturb the basic reaction.

Among the metals that are used in the bottom salts, it is desirable to use those that exhibit, besides the degree 0, only a single degree of stable oxidation.

The electrolyte can be selected such that these cations are directly soluble in the reaction medium. Thus, in particular when the medium is not very polar, rather than to make the metallic cations soluble by means of adjuvants, it may be advantageous to use stable “oniums” in the domain of electric inactivity.

“Onium” is defined as the positively charged organic compounds of which the name that attributes the nomenclature to them comprises an affix, in general a suffix, “onium” (such as sulfonium [trisubstituted sulfur], phosphonium [tetrasubstituted phosphorus], or ammonium [tetrasubstituted nitrogen]). Most used are the tetraalkylammoniums, the alkyl groups that are taken in their etymological meaning in general have 1 to 12 carbon atoms, preferably 1 to 4 carbon atoms. It is also possible to use phase transfer agents.

The anions can be anions that are usual for indifferent electrolytes, but it is preferable that they be selected from among those that are released by the reaction, essentially halides, or, for example, by complex anions of type BF₄⁻, PF₆-, or ClO₄⁻. Among the preferred anions, it is possible to cite those that are obtained from fluorinated acids or their imides (TFSI, triflates, etc.). By way of indication, it should be pointed out that DMF, used with tetrabutylammonium tetrafluoroborate as a bottom salt at the concentration of 0.01 M, yielded good results.

Said electrolysis can be conducted at many temperatures, but it is preferable to conduct this electrolysis at a temperature that is at most equal to 100° C. and at most equal to the boiling point of the solvent.

An interval yielding good results is the interval between 0 and 50° C.; it is a closed interval, i.e., including the limits.

Pressure is of little importance to the electrolysis, except if one of the reagents or the solvent has an especially low boiling point.

For practical reasons, however, the pressure is preferably the atmospheric pressure of the location in question.

In the above-mentioned case where one of the components of the reaction medium is particularly volatile and where it is desired to keep this component in the reaction medium, it is then possible to increase the pressure; this pressure is generally then an autogenbus pressure resulting from the reaction in a closed chamber.

Advantageously, the vinyl ester has the following formula (II):

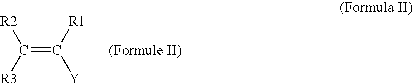

Another object of this invention is to provide a medium that can be used for carrying out electrolysis and that leads to heterocouplings. This object has been achieved by means of a composition that comprises at least:

a cobalt salt,

a conductive solvent or a solvent that was made conductive, and

a cobalt coordinating agent,

a vinyl ester.

The solvent and the coordinating agent of the cobalt can constitute one and the same entity, and even a single compound when the solvent is a single compound.

The cobalt content is advantageously between 2.10⁻³ and 10⁻¹ M, preferably between 5.10⁻³ and 5.10⁻² M (closed interval, i.e., including the limits). When cobalt-soluble anodes are used, the upper limiting values can be exceeded.

Said composition, also comprises an aryl halide, whose preferred chemical characteristics will be presented in detail below. This aryl halide is advantageously present at a concentration of 0.1 to 1 M.

It is desirable that the molar ratio (dissolved radicals) of cobalt to vinyl ester go from 10⁻² to ½, preferably from 0.05 to 0.2 (closed interval, i.e., including the limits). The important limit values are the minimum values. If a cobalt-soluble anode is used, these values can be exceeded.

It is also sensible that the molar ratio (of course, radicals) of vinyl ester to aryl halide be at least equal to 1 and advantageously 1.5, preferably 2, and at most equal to 5, advantageously 4, and preferably 3. Thus, it is usually suitable that this ratio go from 1 to 5 (closed interval, i.e., including the limits). One skilled in the art will optimize this parameter, in particular based on the nature of Y and the aromatic compound with which the vinyl is to be condensed.

According to an advantageous implementation of the invention, the intensity and the surface area of the reactive electrode, more exactly of the electrode where the reaction takes place, are selected such that the density of current; is between 5 and 5.10² A/m², preferably between 20 and 200 A/m² (closed interval, i.e., including the limits).

By routine tests, one skilled in the art can determine the potential for cobalt reduction in the reaction medium and that of aryl halide. This determination made, it will preferably be placed between the cobalt reduction potential and that of the aryl halide.

The aryl-substrates that can be coupled with the vinyls according to this invention represent a wide range of compounds. The halides are generally halides corresponding to relatively heavy halogens, i.e., halogens that are heavier than fluorine; these substrates are noted by formula (I):

Ar—X (Formula I)

It can also be indicated that when the halogen is linked to an aromatic core that is low in electrons, it is preferable to use bromines or chlorines as halogen, the chlorines being reserved for cores that are particularly low in electrons. The condition is almost always met by heterocyclic compounds with six chain links, but in the case of homocyclic aryl hexacyclic substrates, to use a chloride, it is preferable that the sum of the Hammett constants σₚ of the substituents (not taking into account the starting halide) be at least equal to 0.40, preferably 0.50. By contrast, the cores that are especially high in electrons can use iodine as a halide.

For more details on Hanmuett constants, it is possible, for example, to refer to the third edition of the manual written by Professor Jerry March “Advanced Organic Chemistry” (pages 242 to 250) and edited by John Wiley and Sons.

The heterocyclic compounds with five chain links and that comprise as heteroatom a chalcogen (such as furan and thiophene) also yield acceptable results.

As was mentioned above, the reduction in electrons from the core can be caused either by the presence of electroattractor groups as substituents, or, in the case of cores with six chain links, by the replacement of a carbon by a heteroatom. In other words, the core that is reduced in electrons can be a heterocyclic core with six chain links, in particular the heterocyclic cores that have an atom from the column of nitrogen and more particularly the nitrogen.

Among the electroattractor groups leading to good results, it is suitable to cite acyl groups, nitrile groups, sulfone groups, carboxylate groups, trifluoromethyl groups or more generally perfluoroalkyl groups and halogens of a lower order than halide, which will be replaced by the vinyl radical.

Among the donor groups, i.e.; yielding mediocre results with chlorine, but good results with bromine, it is possible to cite alkyloxyl groups, alkyl groups, amine groups and dialkylamine groups.

The aromatic derivative substrate of this process advantageously corresponds to the following formula:

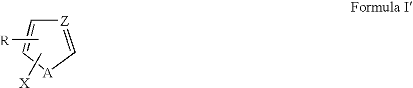

where:

Z represents a trivalent chain link —C(R₁)═, and an atom of column V, advantageously a nitrogen;

X represents the starting halogen;

A represents either a link that is selected from among the ZH groups or from among the chalcogens that are advantageously of an order that is at least equal to that of sulfur, or from among the unsaturated divalent groups with two chain links C R₂═CR₃, N═CR₂ CR₂═N.

To the extent that they are carried by contiguous atoms, two of radicals R, R₁, R₂, and R₃ can be linked to form rings.

Thus, the aryl compounds can be selected in particular from among those of the following compounds:

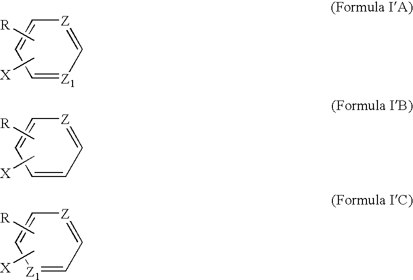

where:

Z₁ is selected from among the same meanings as those provided for Z;

radicals R₁, R₂, and R₃ are selected from among the above-mentioned substituents and in particular:

electroattractor groups, in particular acyl groups, nitrile groups, sulfone groups, carboxylate groups, trifluoromethyl groups, or more generally perfluoroalkyl groups and halogens of a lower order than halide that will be transformed into a coupling product;

donor groups, in particular the aryloxyl groups, alkyloxyl groups, hydrocarbyl groups such as aryl and alkyl (the latter word being used in its etymological meaning), or amine groups, including groups that are mono- and disubstituted by alkylamine hydrocarbon groups.

It is desirable that the substrates have at most 50 carbon atoms, advantageously at most 30 carbon atoms, and preferably at most 20 carbon atoms.

The particularly advantageous substrates include the halides, preferably aryl chlorides, that carry in particular in meta-position an aliphatic carbon (i.e., sp³) that carries at least two fluorines, for example halides, preferably trifluoromethylaryl chlorides.

One of the advantages of this invention is to require only complexing agents or coordinating agents, with easy access, such as nitriles (preferably aromatic or bidentate nitrites), or else the pyridines and the derivatives of the pyridine core, such as quinoline. Furthermore, the bipyridyls, being bidentate, also yield good results as a separate coordinating agent of the solvent.

This description now pertains to the implementation of electrolytic heterocoupling between an aryl (pseudo)halide and an ester, and even an ether, of allyl that consists in subjecting the two substrates to a cathodic reduction in the presence of cobalt (II).

The reaction can be written roughly in the manner below:

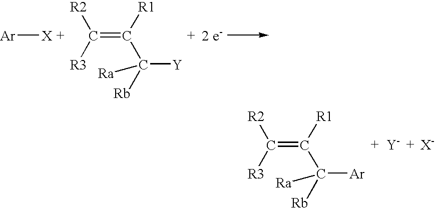

formulas in which:

Y corresponds to a leaving group that can exist in Y⁻ form, such as phenate, and even alcoholate, but advantageously selected from among the halogens and the carboxylates lato sensu and the pseudohalogens.

Ra and Rb, which can be identical or different, are selected from among the hydrocarbyls (i.e., the groups whose open bond is brought by a carbon and that comprises both hydrogen and oxygen) and hydrogens. It is desirable for preventing steric occupancy problems that at least one, preferably two, of the Ra and Rb be hydrogen. Pseudohalogen is defined as designating a group whose removal leads to an oxidized anion, whereby the anionic charge is carried by the chalcogen atom, and whose acidity is most often at least equal to that of the acetic acid, advantageously to the second acidity of the sulfuric acid, and preferably to that of the trifluoroacetic acid. To be located on the scale of acidities, it is suitable to refer to the pKa for the middle to high acidities from the carboxylic acids to the trifluoroacetic acid and to be located on the scale of Hammett constants starting from the trifluoroacetic acid. Carboxylate lato sensu should be defined as any radical such that its anionic form comprises the atomic sequence —CO—O⁻; thus, not only the carboxylate functions that are linked to a carbon atom but also the carbamic acids and the alkylcarbonates are targeted. If it is desired to avoid all parasitic reactions, it is preferable to prevent the substituents comprising reactive hydrogens such as hydrogens on the amides (that are therefore advantageously protected or peralkylated) or on an oxygen.

R₁, R₂ and R₃, which may or may not be different, are selected from among hydrogen, the functions that are more difficult to reduce than the function Y, and from among the hydrocarbon radicals, sometimes designated in this application by the term “hydrocarbyls,” in particular alkyls and aryls; whereby the alkyls are used in the etymological meaning of an alcohol from which was removed the OH function, and comprises, of course, the aralkyls.

Thus, among the functions that are more difficult to reduce than Y, it is possible to cite the ether functions, the carboxylic functions, the functions from among which Y is selected provided that these functions are less reducible than Y. The order of reducibility can be easily determined under the operating conditions by routine experiments. By way of indication, it can be noted that regarding the halides, the higher the atomic number, the more the halide is reducible, and in a more general (and rougher) way, the stronger the acid is which corresponds to the leaving group, the more the corresponding allyl ester is reducible (but it should be noted that the anions can themselves be reduced and cause parasitic reactions).

Among the groups that are relatively reducible and that should be emphasized, it is possible to cite the perfluorinated groups: one of the solutions is to influence the current density.

The hydrocarbon radicals are preferably either of an aromatic nature or an aliphatic nature, i.e., the carbon that ensures the link to the remainder of the molecule is hybridization carbon sp³; these aliphatic radicals are in general alkyls (alkyl is used in the etymological meaning of an alcohol from which the OH function is removed), including aralkyls. It should be pointed out that the hydrocarbon radicals that have a double bond conjugated with the allyl, the site of the reaction, yield only very mediocre results.

In general, the number of carbons from the allyl derivative is less than 50, advantageously 30.

Actually, during the studies that led to this invention, it was shown that in the presence of cobalt, the coupling above took place with good yields.

The reaction is actually an ipso reaction (here, the ablative of the Latin “ipse” is used to indicate that functionalization is done on the same carbon as the one that carried the starting halide or pseudohalide), but in some cases, of course when the allyl group is not palindrome, it was possible to observe small amounts of product corresponding to an SN′2.

Although the form of the cobalt in the vicinity of the cathode had not been completely explained, it was possible to show that the presence of cobalt coordinating agents proved important and made it possible to increase the yields very significantly when they did not sequester very much. By contrast, the strong coordinating agents and primarily the strong bidentates are able to reduce the yield. Strong bidentate suitably means the bidentates of which one of the teeth is at least as complexing with regard to the cobalt as pyridine. The pyridine itself, when it is not engaged in a bidentate, yields excellent results. When reference is made to the bidentate concept, of course, the geometry of the molecule is defined as allowing two teeth to work together and therefore to form a ring with at most, advantageously less than, 7 centers with the cobalt.

Although an effect can be demonstrated when solvents that have the property of coordinating the cobalt are used, it is sometimes preferable to use specific coordinating agents.

If a return is made to the agents or solvation agents that make it possible to improve the yield significantly, it is possible to indicate that it is possible to use compounds that have a high donor index. More specifically, it is possible to indicate that it is preferable that donor index D of these solvents, or of these solvation agents, is greater than or equal to 10, preferably less than or equal to 30, advantageously between 20 and 30, including the limits. Said donor index corresponds to ΔH (enthalpy variation) that is expressed in kilocalories of the combination of said polar aprotic solvent or said coordinating agent with antimony pehtachloride.

This is described more specifically in the work of Christian Reichardt: “Solvents and Solvent Effects in Organic Chemistry” —VCH, page 19, 1988. On this page is found the definition of the donor index that is expressed in English terms by “donor number.”

The results are better if the atom that coordinates the cobalt in said solvent or solvation agent is an atom from the column of nitrogen, and advantageously the nitrogen itself.

When a specific coordinating agent that does not play the role of solvent is used, it is possible to cite the functions or group of pyridine, nitrile, phosphine, stibine and imine.

To be effective, it is desirable that the cobalt be present at a minimum concentration of at least 10⁻³ M. Except in the case of strong bidentates, it is preferable that the ratio between the coordinating agents and the cobalt that is expressed in mol (coordinating agent(s)/Co) be at least equal to 1, advantageously 2, and preferably 5.

To be economical, it is preferable that the cobalt not be too concentrated; it is also preferred that the cobalt content be at most equal to 0.2 M.

The reaction medium advantageously comprises a solvent, and this solvent should be polar enough to dissolve the metals or more exactly the salts of the metals that are used, and it should be lipophilic enough to dissolve, at least partially, the substrates from which it is desired to form the allyl aryl.

It is preferable to use solvents that are low enough in acid so that the reactions with hydrogen are as little pronounced as possible. Thus, the primary alcohols are too acidic.

More specifically, the so-called polar aprotic solvents, such as the following, for example, alone or in a mixture, will be preferred:

Purely oxidized solvents, in particular ethers, preferably polyethers such as dimethoxy-1,2-ethane or cyclic ethers such as THF or dioxane;

amides or ureas (DMF, N-methylpyrrolidone-2, imidazolidone, tetramethyl urea, dimethoxypropylene-urea, etc.);

sulfones (for example, sulfolane) or sulfoxides (such as DMSO);

and, to the extent that they are liquid under the operating conditions, nitrogen-containing derivatives, nitrogen-containing heterocyclic compounds, in particular pyridine, and compounds with a nitrile function (for those that are preferred, see below);

and, to the extent that they are liquid under the operating conditions, complexing agents (crown ether, HMPT) that improve the smooth running of the reaction by increasing conductivity, increasing the reactivity of the anion, and preventing metal deposits on the cathode.

Without this explanation being limiting, it would seem that these advantageous phenomena are correlated with the capacity to complex the metallic cations or in a mixture.

As indicated above, the solvents that are used can themselves play the part of complexing agents or coordinating agents. They can in particular have one or more of the functions of coordination mentioned above.

The solvent can be a mixture of an apolar solvent and a polar solvent as defined above by the donor index.

When the solvent is not in itself a complexing agent of the cobalt that is strong enough to obtain optimum results, it is then desirable to use one of the complexing agents that is specific for cobalt, advantageously non-polydentate, and even non-bidentate, primarily when one of the teeth is a pyridine function. As functions that play the role of teeth, it is suitable to cite the nitrites (preferably aromatic and/or bidentate nitriles), or else the pyridines and the derivatives of the pyridine core, such as quinoline. Alone, the dinitriles yield very good results.

The bipyridyls, being bidentate, thus yield mediocre results as separate complexing agents of the solvent. It is preferable that the complexing agents of the bidentate cobalt that comprise at least one pyridine as a tooth have a smaller amount than that of the cobalt (expressed in mol per liter).

More specifically, according to this invention, when the vinyl compounds are not treated, it is preferable that the complexing agents that are pyridinic in nature and that are expressed in terms equivalent to the pyridinic function or strong function be less than 2× the amount expressed in mol of cobalt salts, preferably less than 1×.

It is also desirable that the same rules apply to strong complexing agents of cobalt, such as the optionally bidentate amines and phosphines.

The preferred complexing agents are those that do not carry a charge, primarily negative, on the atom, or on the atoms that carry the bond coordinating the cobalt; it is also preferable that when said complexing agent carries a charge, the latter be located on the shortest path to at least 4, and even advantageously to at least 5 atoms, preferably 6, primarily when said charge is negative. Thus, the cyanides are not desirable as complexing agents of cobalt.

To facilitate the separation of products with the reaction media, it is preferable that said solvent exhibits a boiling point that is essentially different from the compound that is to be synthesized and the starting compound.

To facilitate the reaction and to improve the conductivity of the medium, in general saline electrolytes, sometimes called bottom salts, optionally modified by the presence of complexing agents, are used. These electrolytes are selected such that they do not disturb the reactions with the anode and cathode. The latter is advantageously inert.

According to one of the most economical implementations of this invention, a salt whose cations correspond to metals of the anode can be used as a bottom salt if a soluble anode is used. Among the soluble anodes, it is possible to cite the anodes that contain iron and/or cobalt, and in particular the anodes that are made of cobalt alloy, of cobalt itself, or of ferro-cobalt.

The electrolyte can be selected so as to have as cations metals with a high transporting power such as the divalent metals, advantageously trivalent metals, or aluminum-type metals, provided that this does not disturb the basic reaction.

Among the metals that are used in the bottom salts, it is desirable to use those that exhibit, besides the degree 0, only a single degree of stable oxidation.

The electrolyte can be selected such that these cations are directly soluble in the reaction medium. Thus, in particular when the medium is not very polar, rather than to make the metallic cations soluble by means of adjuvants, it may be advantageous to use stable “oniums” in the domain of electric inactivity.

“Onium” is defined as the positively charged organic compounds of which the name that attributes the nomenclature to them comprises an affix, in general a suffix, “onium” (such as sulfonium [trisubstituted sulfur], phosphonium [tetrasubstituted phosphorus], or ammonium [tetrasubstituted nitrogen]). Most used are the tetraalkylamrmoniums, the alkyl groups that are taken in their etymological meaning in general have 1 to 12 carbon atoms, preferably 1 to 4 carbon atoms. It is also possible to use phase transfer agents.

The anions can be anions that are usual for indifferent electrolytes, but it is preferable that they be selected from among those that are released by the reaction essentially halides, or, for example, by complex anions of type BF₄⁻, PF₆-, or ClO₄⁻. Among the preferred anions, it is possible to cite those that are obtained from fluorinated acids or their imides (bis-trifluoromethylsulfonimides, triflates, etc.). By way of indication, it should be pointed out that DMF, used with tetrabutylammonium tetrafluoroborate as a bottom salt at the concentration of 0.01 M, yielded good results.

Said electrolysis can be conducted at many temperatures, but it is preferable to conduct this electrolysis at a temperature that is at most equal to 100° C. and at most equal to the boiling point of the solvent.

An interval yielding good results is the interval between 0 and 50° C.; it is a closed interval, i.e., including the limits.

Pressure is of little importance to the electrolysis, except if one of the reagents or the solvent has a particularly low boiling point. For practical reasons, however, the pressure is preferably the atmospheric pressure of the location in question.

In the above-mentioned case where one of the components of the reaction medium is especially volatile and where it is desired to keep this component in the reaction medium, it is then possible to increase the pressure; this pressure is generally then an autogenous pressure resulting from the reaction in a closed chamber.

Another object of this invention is to provide a medium that can be used for carrying out electrolysis and that leads to heterocouplings. This object has been achieved by means of a composition that comprises at least:

a cobalt salt,

a conductive solvent or a solvent that was made conductive, and

a cobalt coordinating agent,

an allyl ester or an allyl ether or even a homoallyl ester or homoallyl ether.

The solvent and the coordinating agent of the cobalt can constitute one and the same entity, and even a single compound when the solvent is a single compound.

The cobalt content is advantageously between 2.10⁻³ and 10⁻¹ M, preferably between 5.10⁻³ and 5.10⁻² M (closed interval, i.e., including the limits). When cobalt-soluble anodes are used, the upper limiting values can be exceeded.

Said composition also comprises an aryl halide (Ar—X), whose preferred chemical characteristics will be presented in detail below. This aryl halide is advantageously present at a concentration of at least 0.01 M, preferably 0.1 to 1 M.

It is desirable that the allyl ester or allyl ether be at least at a concentration (dissolved) of 0.01 M.

It is desirable that the molar ratio (dissolved radicals) of cobalt to allyl ester go from 10⁻² to ½, preferably from 0.05 to 0.2 (closed interval, i.e., including the limits). The important limit values are the minimum values. If a cobalt-soluble anode is used, these values can be exceeded.

It is also sensible that the molar ratio (of course, radicals) of allyl ester or allyl ether to aryl halide be at least equal to 1 and advantageously 1.5, preferably 2, and at most equal to 5, advantageously 4, and preferably 3. Thus, it is usually suitable that this ratio go from 1 to 5 (closed interval, i.e., including the limits). One skilled in the art will optimize this parameter, in particular based on the nature of Y and the aromatic compound with which the allyl is to be condensed.

According to an advantageous implementation of the invention, the intensity and the surface area of the reactive electrode, more exactly of the electrode where the reaction takes place, are selected such that density of current j is between 5 and 5.10² A/m², preferably between 20 and 200 A/m² (closed interval, i.e., including the limits).

By routine tests, one skilled in the art can determine the potential for cobalt reduction in the reaction medium and that of aryl halide. This determination made, it will preferably be placed between the cobalt reduction potential and that of the aryl halide.

The aryl substrates (Ar—X) that can be coupled with the allyls according to this invention represent a wide range of compounds. The halides are generally halides corresponding to relatively heavy halogens, i.e., halogens that are heavier than fluorine.

It can also be indicated that when the halogen is linked to an aromatic core that is low in electrons, it is preferable to use bromines or chlorines as halogen, the chlorines being reserved for cores that are especially low in electrons. The condition is almost always met by heterocyclic compounds with six chain links, but in the case of homocyclic aryl hexacyclic substrates, to use a chloride, it is preferable that the sum of the Hammett constants σₚ of the substituents (not taking into account the starting halide) is at least equal to 0.40, preferably 0.50. By contrast, the cores that are especially high in electrons can use iodine as a halide.

For more details on Hammett constants, it is possible, for example, to refer to the third edition of the manual written by Professor Jerry March “Advanced Organic Chemistry” (pages 242 to 250) and edited by John Wiley and Sons.

The heterocyclic compounds with five chain links and that comprise as heteroatom a chalcogen (such as furan and thiophene) also yield acceptable results.

As was mentioned above, the reduction in electrons from the core can be caused either by the presence of electroattractor groups as substitutents, or, in the case of cores with six chain links, by the replacement of a carbon by a heteroatom. In other words, the core that is reduced in electrons can be a heterocyclic core with six chain links, in particular the heterocyclic cores that have an atom from the column of nitrogen and more particularly the nitrogen.

Among the electroattractor groups leading to good results, it is suitable to cite acyl groups, nitrile groups, sulfone groups, carboxylate groups, trifluoromethyl groups or more generally perfluoroalkyl groups and halogens of a lower order than halide, which will be replaced by the vinyl radical.

Among the donor groups, i.e., yielding mediocre results with chlorine, but good results with bromine, it is possible to cite alkyloxyl groups, alkyl groups, amine groups and dialkylamine groups.

The aromatic derivative substrate of this process advantageously corresponds to the following formula:

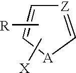

where:

Z represents a trivalent chain link —C(R₁)═, and an atom of column V, advantageously a nitrogen;

X represents the starting halogen;

A represents either a link that is selected from among the ZH groups or from among the chalcogens that are advantageously of an order that is at least equal to that of sulfur, or from among the unsaturated divalent groups with two chain links C R₂═CR₃, N═CR₂ CR₂═N.

To the extent that they are carried by the contiguous atoms, two of radicals R, R₁, R₂, and R₃ can be linked to form rings.

Thus, the aryls can have in particular the formula:

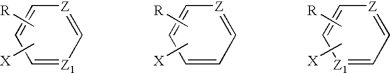

where:

Z₁ is selected from among the same meanings as those provided for Z;

radicals R₁, R₂, and R₃ are selected from among the substituents that are mentioned above and in particular:

electroattractor groups, in particular acyl groups, nitrile groups, sulfone groups, carboxylate groups, trifluoromethyl groups, or more generally perfluoroalkyl groups and halogens of a lower order than halide that will be transformed into a coupling product;

donor groups, in particular the aryloxyl groups, alkyloxyl groups, hydrocarbyl groups such as aryl and alkyl (the latter word being used in its etymological meaning), or amine groups, including groups that are mono- and disubstituted by alkylamine hydrocarbon groups.

It is desirable that the substrates have at most 50 carbon atoms, advantageously at most 30 carbon atoms, and preferably at most 20 carbon atoms.

The particularly advantageous substrates include the halides, preferably aryl chlorides, that carry in particular in meta-position an aliphatic carbon (i.e., sp³) that carries at least two fluorines, for example halides, preferably trifluoromethylaryl chlorides.

One of the advantages of this invention is to require only complexing agents or coordinating agents, with easy access, such as nitrites (preferably aromatic or bidentate nitriles), or else the pyridines and the derivatives of the pyridine core, such as quinoline. Furthermore, the bipyridyls, being bidentate, also yield good results as a separate coordinating agent of the solvent.

The following non-limiting examples illustrate the invention.

### EXAMPLE THAT PERTAIN TO ARYL-ALLYL COUPLING

### General Operating Procedure in the Case of Aromatic Bromides

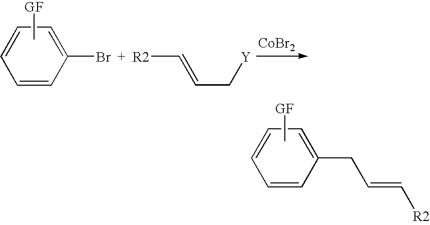

GF représente un groupe fonctionnel correspondent àR dans la formule générale et Y est ici un carboxylate de formule Y′—COO—

[GF represents a functional group that corresponds to R in the general formula, and Y here is a carboxylate of formula Y′—COO—.]

Device

Electrolysis cell with a single compartment that is equipped with an iron anode and a cathode that consists of a stainless steel grid (cathodes that consist of a nickel foam or a gold grid can also be used).

Solvent: acetonitrile-pyridine (45 ml-5 ml)

Temperature: 50° C.

Aryl bromide: 7.5 millimol

Cobalt bromide: 1 millimol

Allyl acetate: 20 millimol

Constant intensity: 0.2 A

Indifferent electrolyte: tetrabutylammonium tetrafluoroborate (10⁻² M)

Electrode surface area: 20 cm²

Duration of electrolysis: 4 hours

The conditions that deviate from the general operating procedure are specified in the tables below, which provide a sample of the results that are obtained (Table 1).

TABLE 1

| | | | | Isolated |
|---|---|---|---|---|
| ArBr | R₂ | Y′ | Product | Yield % |
| 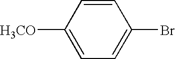 | H | CH₃ | 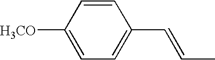 | 74 |
| 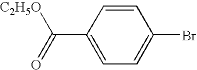 | H | CH₃ | 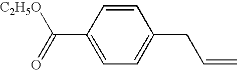 | 70 |
| 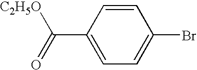 | Ph | CH₃ | 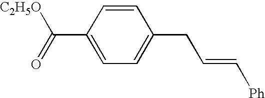 | 52 |
| 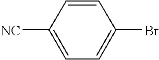 | H | CH₃ | 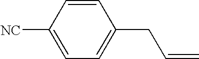 | 64 |
| 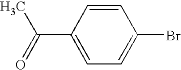 | H | CH₃ | 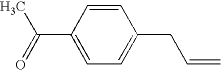 | 41 |
| 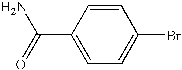 | H | CH₃ | 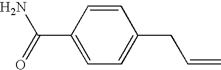 | 30 |
| 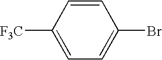 | H | CH₃ | 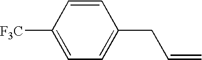 | 62 |
| 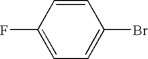 | H | CH₃ | 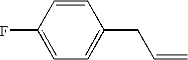 | 51^{a} |
| 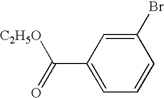 | H | CH₃ | 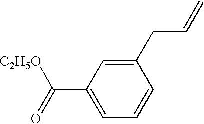 | 64 |
| 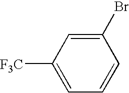 | H | CH₃ | 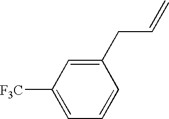 | 57 |
| 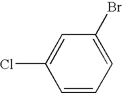 | H | CH₃ | 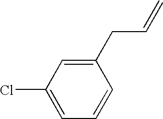 | 58 |
| 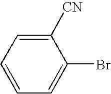 | H | CH₃ | 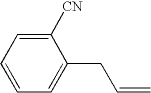 | 63 |
| 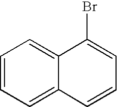 | C(CH₃)═CH₂ | CH₃ | 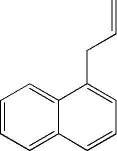 | 86 |

^{a}The electrolysis period is 8 hours

### General Operating Procedure in the Case of Aromatic Chlorides

Device

Electrolysis cell with a single compartment that is equipped with an iron anode and a cathode that consists of a stainless steel grid (cathodes that consist of a nickel foam or a gold grid can also be used).

Solvent: acetonitrile-pyridine (45 ml-5 ml)

Temperature: 50° C.

Aryl bromide: 5 millimol

Cobalt bromide: 2 millimol

Allyl acetate: 10 millimol

Constant intensity: 0.2 A

Indifferent electrolyte: tetrabutylammonium tetrafluoroborate (10⁻² M)

Electrode surface area: 20 cm²

Duration of the electrolysis: 7 hours

The conditions that deviate from the general operating procedure are specified in the tables below, which provide a sample of the results that are obtained (Table 2).

TABLE 2

| | | | | Isolated |
|---|---|---|---|---|
| ArCl | R₂ | Y′ | Product | Yield % |
| 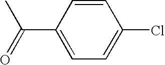 | H | CH₃ | 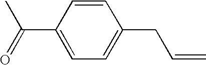 | 60 |
| 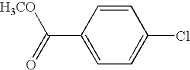 | H | CH₃ | 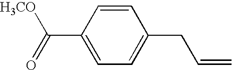 | 81 |
| 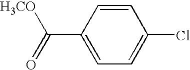 | CH₃ | CH₃ | 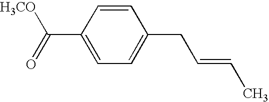 | 70 (including 19 SN2′) |
| 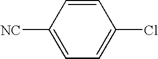 | H | CH₃ | 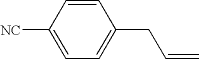 | 66 |
| 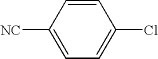 | H | C(CH₃)═CH₂ | 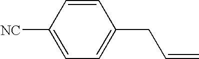 | 76 |
| 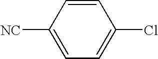 | H | nC₆H₁₃ | 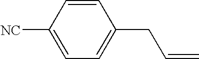 | 58 |
| 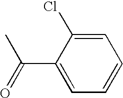 | H | CH₃ | 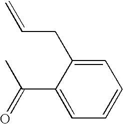 | 50 |
| 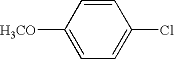 | H | CH₃ | 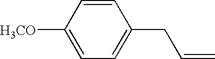 | 5 |
| 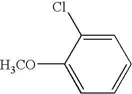 | H | CH₃ | 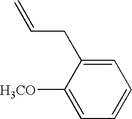 | 5 |

### General Operating in the Case of Heteroaromatic Halides

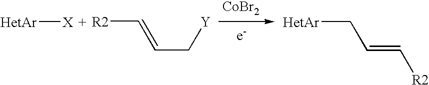

Y est ici un carboxylate de formule Y′—COO—

[Y here is a carboxylate of formula Y′—COO—.]

Device

Electrolysis cell with a single compartment that is equipped with an iron anode and a cathode that consists of a stainless steel grid (cathodes that consist of a nickel foam or a gold grid can also be used).

Solvent: acetonitrile-pyridine (45 ml-5 ml)

Temperature: 50° C.

Heteroaryl halide: 5 millimol

Cobalt bromide: 2 millimol

Allyl acetate: 10 millimol

Constant intensity: 0.2 A

Indifferent electrolyte: tetrabutylammonium tetrafluoroborate (10⁻² M)

Electrode surface area: 20 cm²

Duration of the electrolysis: 4 hours

The conditions that deviate from the general operating procedure are specified in the tables below, which provide a sample of the results that are obtained (Table 3).

TABLE 3

| | | | | Isolated |
|---|---|---|---|---|
| HetArX | R₂ | Y′ | Product | Yield % |
| 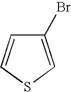 | H | C(CH₃)═CH₂ | 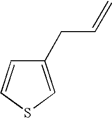 | 70 |
| 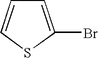 | H | C(CH₃)═CH₂ | 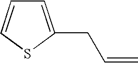 | 20 |
| 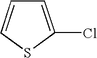 | H | C(CH₃)═CH₂ | 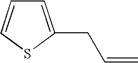 | 63 |
| 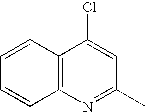 | H | C(CH₃)═CH₂ | 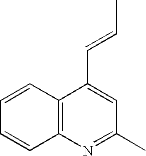 | 69 |

### General Operating Procedure in the Case of Other Allyl Derivative

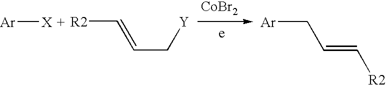

Y est ici un carboxylate de formula Y′—COO—

[Y here is a carboxylate of formula Y′—COO—.]

Device

Electrolysis cell with a single compartment that is equipped with an iron anode and a cathode that consists of a stainless steel grid (cathodes that consist of a nickel foam or a gold grid can also be used).

Solvent: acetonitrile-pyridine (45 ml-5 ml)

Temperature: 50° C.

Aromatic bromide: 7.5 millimol (aromatic chloride: 5 millimol)

Cobalt bromide: 1 millimol (2 millimol for aromatic chloride)

Allyl derivative: 20 millimol (10 millimol for aromatic chloride)

Constant intensity: 0.2 A

Indifferent electrolyte: tetrabutylammonium tetrafluoroborate (10⁻² M)

Electrode surface area: 20 cm²

Duration of the electrolysis: 4 hours

The conditions that deviate from the general operating procedure are specified in the tables below, which provide a sample of the results that are obtained (Table 4).

TABLE 4

| ArX | R₂ | Y′ | Product | Yield % |
|---|---|---|---|---|
| 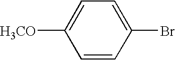 | H | OCH₃ | 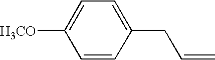 | 50 |
| 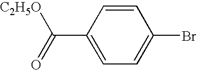 | H | OCH₃ | 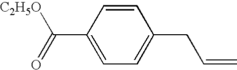 | 79 |
| | | | | 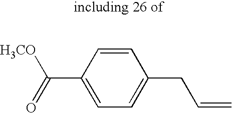 |
| 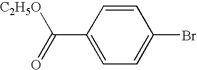 | H | Y = OC₂H₅ | 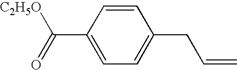 | Presence, but at most 10 |
| 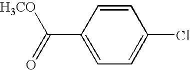 | H | O—CH₃ | 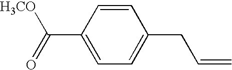 | 26 |
| 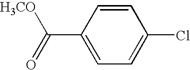 | H | Y = Cl | 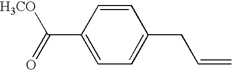 | Presence, but at most 5 |

### EXAMPLES OF AROMATIC VINYLATION

### Operating Procedure of examples of Vinylation of Aromatic Bromides

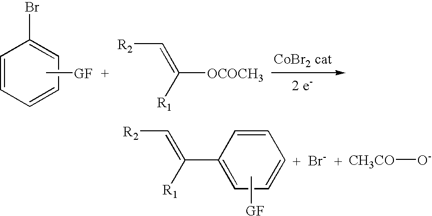

Device

Electrolysis cell with a single compartment that is equipped with an iron anode and a cathode that consists of a stainless steel grid (cathodes that consist of a nickel foam or a gold grid can also be used).

Operating Conditions

Solvent: acetonitrile-pyridine (45 ml-5 ml)

Ambient temperature: (20 to 25° C.)

Constant intensity: 0.2 A

Indifferent electrolyte: tetrabutylammonium tetrafluoroborate (10⁻² M)

Electrode surface area: 20 cm²

Duration of electrolysis: 4 hours

Reagents

Aryl bromide: 10 millimol

Cobalt bromide: 1 millimol

2,2′-bipyridine: 10 millimol

Vinyl acetate: 25 millimol

The conditions that deviate from the general operating procedure are specified in the tables below, which provide a sample of the results that are obtained (Table 1).

TABLE 5

| | | | | Isolated |
|---|---|---|---|---|
| ArBr | R₁ | R₂ | Product | Yield % |
| 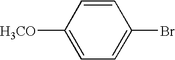 | H | H | 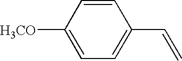 | 62 |
| 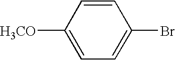 | CH₃ | H | 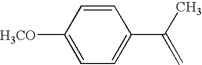 | 61 |
| 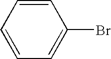 | H | H | 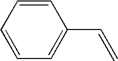 | 52 |
| 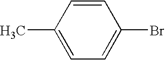 | H | H | 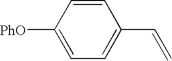 | 44 |
| 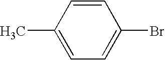 | H | H | 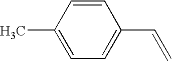 | 53 |
| 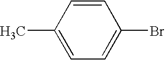 | CH₃ | H | 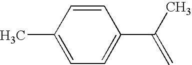 | 47 |
| 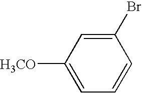 | H | H | 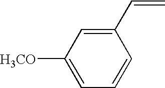 | 54 |
| 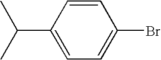 | H | H | 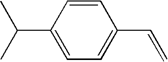 | 40 |
| 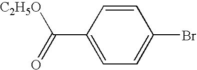 | H | H | 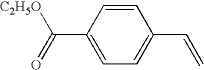 | 5 |
| 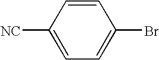 | H | H | 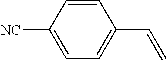 | 5 |

### General Operating Procedure in the Case of Aromatic Chloride

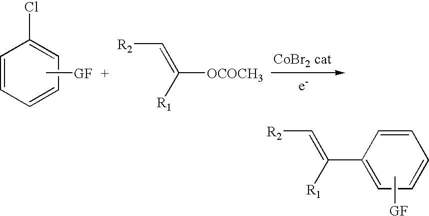

Device

Electrolysis cell with a single compartment that is equipped with an iron anode and a cathode that consists of a stainless steel grid (cathodes that consist of a nickel foam or a gold grid can also be used).

Solvent: acetonitrile-pyridine (45 ml-5 ml)

Ambient temperature (20-25° C.)

Aryl bromide: 10 millimol

Cobalt bromide: 2 millimol

2,2′Bipyridine: 10 millimol

Vinyl acetate: 25 millimol

Constant intensity: 0.2 A

Indifferent electrolyte: tetrabutylammonium tetrafluoroborate (10⁻² M)

Electrode surface area: 20 cm²

Duration of electrolysis: 4 hours

The conditions that deviate from the general operating procedure are specified in the tables below, which provides a sample of the results that are obtained (Table 6).

TABLE 6

| | | | | Isolated |
|---|---|---|---|---|
| ArCl | R₁ | R₂ | Product | Yield % |
| 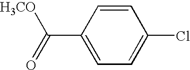 | H | H | 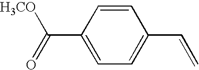 | 57 |
| 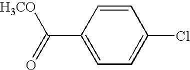 | CH₃ | H | 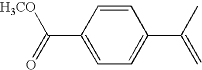 | 92 |
| 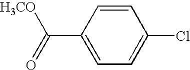 | 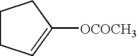 | | 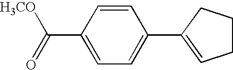 | 70 |
| 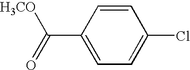 | 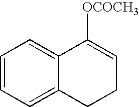 | | 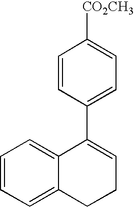 | 57 |
| 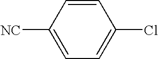 | H | H | 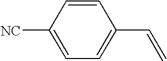 | 15 |
| 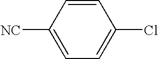 | CH₃ | H | 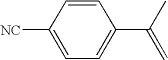 | 20 (58 of GC) |
| 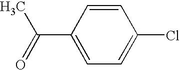 | H | H | 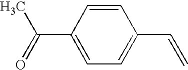 | 60 |
| 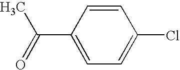 | CH₃ | H | 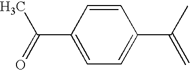 | 76 |
| 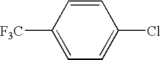 | CH₃ | H | 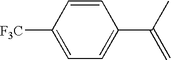 | 81 |
| 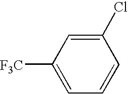 | CH₃ | H | 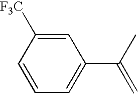 | 74 |
| 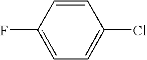 | CH₃ | H | 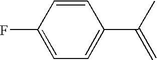 | 67^{a} |

^{a}The electrolysis period is 8 hours

1) Use of cobalt as a catalyst for electrolytic heterocoupling between an aryl (pseudo)halide and a vinyl ester.

Process for electrolytic heterocoupling between an aryl (pseudo)halide and a vinyl ester that consists in subjecting the two substrates to a cathodic reduction in the presence of cobalt (II).

1: A method for electrolytic heterocoupling between an aryl (pseudo)halide and a derivative that carries a double bond and a leaving group in vinyl-position, allyl-position, and even homoallyl-position of said double bond comprising using a cobalt catalyst.

2: The method according to claim 1, wherein the cobalt is present in oxidation state 2.

3: The method according to claim 1, wherein the cobalt is present in a coordinated form.

4: The method according to claim 3, wherein the coordination of the cobalt is carried out by a solvent compound or solvating compound that has a high donor index.

5: The method according to claim 4, wherein the atom that is responsible for a good donor index is selected from among the atoms of the nitrogen column.

6: The method according to claim 3, wherein the coordination of the cobalt is carried out by a specific coordinating agent.

7: The method according to claim 6, wherein said coordinating agent has functions that are selected from among the pyridine, nitrile, phosphine, stibine and imine functions.

8: The method according to claim 1, wherein the anode is a soluble anode.

9: The method according to claim 8, wherein said soluble anode contains iron and/or cobalt.

10: The method according to claim 8, wherein said soluble anode is an alloy of cobalt or cobalt itself.

11: The method according to claim 1, wherein said derivative that carries a double bond and a leaving group is a vinyl ester.

12: The method according to claim 11, wherein the ratio of (coordinating agent(s)/cobalt) between coordinating agent(s), expressed in mol for the monodentates and in equivalent terms for the polydentates and the cobalt ions (expressed in mol) is at least equal to 0.5.

13: The method according to claim 1, wherein said derivative that carries a double bond and a leaving group is an allyl ester or an allyl ether.

14: The method according to claim 13, wherein the ratio of/is greater than 1.

15: The method according to claim 13, wherein the cobalt/pyridine equivalent ratio is greater than 1.

16: Composition that comprises at least one cobalt salt, a solvent that is optionally conductive or made conductive, a cobalt coordinating agent, and a derivative that carries a double bond and a leaving group.

17: Composition according to claim 16, wherein the cobalt content is between 2×10⁻³ et 10⁻¹M.

18: Composition according to claim 16, which comprises a solvent that is selected from among the components below, alone or in a mixture:
Purely oxidized solvents;
Amides, including ureas;
Sulfones or sulfoxides;
Nitrogen-containing derivatives;
Complexing agents.

19: Composition according to claim 16, wherein the molar ratio of dissolved radical between the cobalt and a derivative that carries a double bond and a leaving group goes from 10⁻² to 0.5.

20: Process of synthesis by an electrolytic method of aryl and a derivative that carries a double bond and a leaving group, which comprises subjecting a composition according to claim 16, also comprising an aryl (pseudo)halide, to electrolysis on an inert cathode.

21: Process according to claim 20, wherein the cathodic current density is included in the closed interval from 5 to 5×10² A/m².
